(19) United States
(12) Patent Application Publication
(10) Pub. No.: US 2014/0297421 A1
(43) Pub. Date: Oct. 2, 2014

(54) SYSTEMS AND METHODS FOR TEXT BASED TARGETED ADVERTISING

(71) Applicant: SPLASHAD, INC., RANCHO SANTA FE, CA (US)

(72) Inventor: WILLIAM K. MOORE, RANCHO SANTA FE, CA (US)

(73) Assignee: SPLASHAD, INC., RANCHO SANTA FE, CA (US)

(21) Appl. No.: 14/215,953

(22) Filed: Mar. 17, 2014

Related U.S. Application Data
(60) Provisional application No. 61/801,124, filed on Mar. 15, 2013.

(51) Int. Cl. G06Q 30/02

(52) U.S. Cl. CPC G06Q 30/0267
USPC 705/14.64; 705/14.49

(57) ABSTRACT

A context sensitive targeted advertisement. system, comprising an advertisement database configured to store a plurality of advertisements, a text analysis engine configured to: receive a message sent by a user using the users mobile device, and search the message and recognize the message context; an ad insertion engine, coupled with the text analysis engine and the advertisement database, the ad insertion engine configured to: select one of the plurality of advertisements based on the context of the message, and insert the advertisement into the received message.

### BACKGROUND

1. Technical Field

The embodiments described herein are related to targeted advertising and in particular to text based targeted advertising systems and methods.

2. Related Art

There are numerous target advertising concepts, from daily deals, to location based systems; however, none of these conventional systems incorporates the ability to understand what the consumer is interested at the precise moment the ad is delivered. For example, daily deal services may understand a demographic or region and attempt to present daily deals based thereon. But they typically have no way of understanding what particular consumers are interested in at the moment they see the daily deal. Location based, e.g., push services have the ability to know where the user is, usually using GPS in their cellphones. As such, these services can push ads related to merchants close to the consumer's location. But they have no way of knowing whether the consumer is actually interested in anything the nearby merchants have to offer.

### SUMMARY

A platform for mobile context sensitive, targeted advertising is described herein.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an targeted advertising system in accordance with one embodiment;

FIG. 2 example workflow for the context sensitive targeted advertising system of FIG. 1 in accordance with one embodiment;

FIG. 3 is a diagram illustrating an example process for creating a user account within the system of FIG. 1 in accordance with one embodiment, and

FIG. 4 is a diagram illustrating a processing system on which one or more of the processes described herein may be executed, according to an embodiment

### DETAILED DESCRIPTION

Appendix A present further information on the context sensitive, target advertising systems and methods described herein.

In certain embodiments, when a user of a mobile device, such as a cellphone, smartphone, tablet, etc., sends a message to another user, such as a text message, or email, the text of the message can be parsed in order to determine the subject(s) or context of the communication. For example, if the user is sending a message asking the other user to meet for dinner tomorrow night, then the system can recognize that dinner tomorrow night is the context. The system can also determine the user's location, either using the UPS in the user device, triangulation, or any other method that can be used, including the content of the message being sent to determine the user's location. The system can then insert an advertisement, coupon, special offer, etc., into the message being sent. Thus, when the other user gets the message about dinner, an, e.g., coupon can be imbedded for a restaurant nearby good for tomorrow night. This is illustrated in the first two pages of the Appendix.

In certain embodiments, users can sign up and provide information such as favorite restaurants, shops, etc., so that the offers included in the messages can also be based on these user preferences, Moreover, the system can be configured to track what offers are redeemed by which users. Often, a user's actual behavior and preferences is deferent from what they indicate in their profile. Thus, the system can learn the user's preferences and select offers accordingly.

The system can also be used to track, trends, behaviors, etc., across large populations and demographics. For instance, the system my recognize that users that got a coffee in a certain location also often visit a certain shop or restaurant. This can be used to tailor which messages are sent to which users and when.

All of the information as to offers sent, offers redeemed, by whom, etc., can be stored and presented to advertisers to allow them to better target their customers.

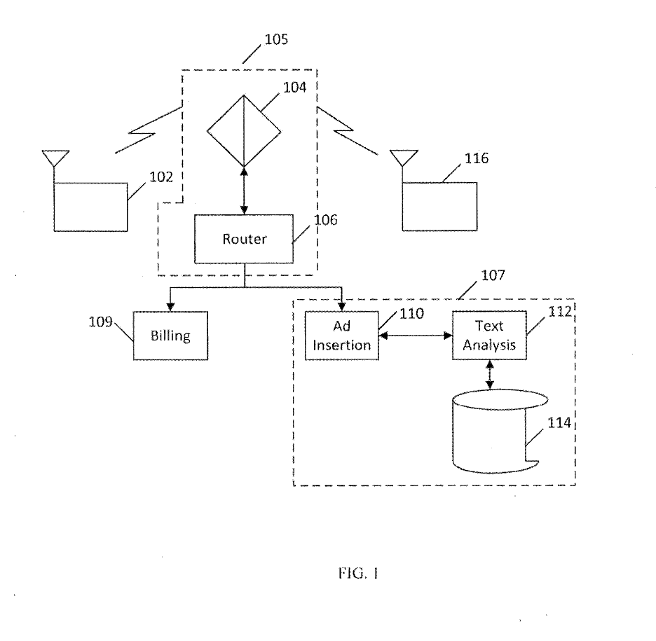

FIG. 1 is a diagram illustrating an example context sensitive, targeted advertising system in accordance with one embodiment, As can be seen, users can send messages, such as text messages, to each other using their devices 102 and 116, The messages will be routed by carrier system 105, which can comprise base station 104 and message router 106. Router 106 can interface with a backend billing system 108 as well as context sensitive targeted advertising system 107. System 107 can include a text analysis engine 112, Ad insertion engine 110, and advertisement database 114.

When a message is received by system 107, text analysis engine 112 can search the text and recognize context, subjects, etc., ad insertion engine 110 can then select an advertisement form advertisement data base 114 based on the context as well as the user profile of the sender of the message, receiver of the message, or both. The selected ad can then be inserted in the message and the message routed to the recipient.

It will be understood that FIG. 1 is a high level view of the system and that numerous components and detail are left out for convenience; however, the diagram should not be seen as limiting the systems and methods described herein,

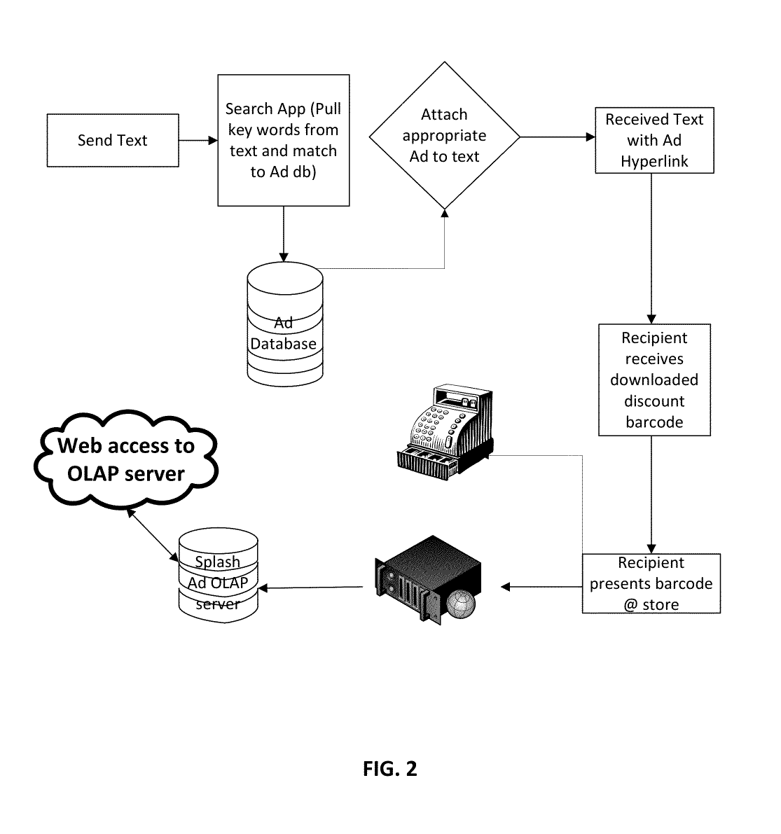

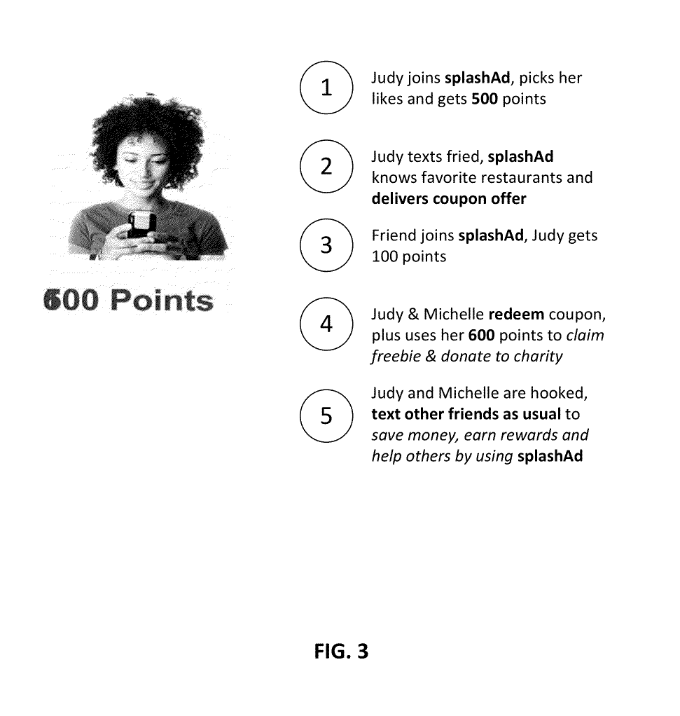

FIG. 2 is a diagram illustrating a workflow for ad insertion in the system of FIG. 1. FIG. 3 is a diagram illustrating an example process for how a user can sign up, create a profile and use the system of FIG. 1.

As can be seen in FIG. 3, a reward program can also be implement in conjunction with the system.

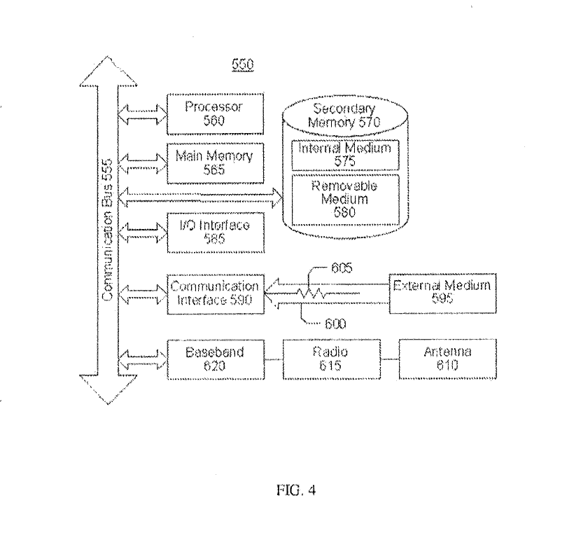

FIG. 4 is a block diagram illustrating an example wired or wireless system 550 that can be used in connection with various embodiments described herein. For example the system 550 can be used as or in conjunction with one or more of the mechanisms or processes described above, and may represent components of device, the corresponding backend server(s), and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550, The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPM), IEEE 696/S-IOU, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM), Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc, The removable medium 580 is read from and/or written to in a well-known manner. Removable storage medium 580 may be, for example, a floppy disk, magnetic tape, CD, MD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550, Such means may include, for example, an external storage medium 595 and an interface 590, Examples of external storage medium 595 may include an external hard disk drive or an external optical drive, or and external magneto-optical drive,

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources.

For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/internet protocol (TCP/IP), serial line Internet protocol/point to point protocol (SLIP/PPP), and so on, but may also implement customized or non-standard interface protocols as well,

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like, Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620, In the system 550, radio frequency (RE) signals are transmitted and received over the air by the antenna system 610 under the management of the radio system 615.

In one embodiment, the antenna system 610 may comprise one or more antennae and one or more multiplexors not shown) that perform a switching function to provide the antenna system 610 with transmit and receive signal paths. In the receive path, received RE signals can be coupled from a multiplexor to a low noise amplifier (not shown) that amplifies the received RE signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RE carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated. circuits (ASICs), or field programmable gate arrays (FPGAs), implementation of a hardware state machine capable of performing the functions described herein will also be apparent to those skilled in the relevant art. Various embodiments may also be implemented using a combination of both hardware and software,

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein, general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A context sensitive targeted advertisement system, comprising:
an advertisement database configured to store a plurality of advertisements,
a text analysis engine configured to:
receive a message sent by a user using the user's mobile device, and
search the message and recognize the message context;
an ad insertion engine, coupled with the text analysis engine and the advertisement database, the ad insertion engine configured to:
select one of the plurality of advertisements based on the context of the message, and
insert the advertisement into the received message.

2. The system of claim 1, further comprising a plurality of user profiles, and wherein the advertisement is selected based on at least one of the plurality of user profiles as well.

3. The system of claim 1, wherein the plurality of advertisements comprises at least one of an advertisement, coupon, and special offer.

4. The system of claim 1, wherein the received message is a text message.

5. The system of claim 1, wherein the system is further configured to implement a rewards system.
